(19) United States
(12) Patent Application Publication
(10) Pub. No.: US 2004/0106369 A1
(43) Pub. Date: Jun. 3, 2004

(54) SYSTEM AND METHOD FOR AN INTERACTIVE DONATION CANISTER

(75) Inventor: Mick Shannon, Draper, UT (US)

Correspondence Address: SNELL & WILMER, ONE ARIZONA CENTER, 400 EAST VAN BUREN, PHOENIX, AZ, 850040001

(73) Assignee: OSMOND FOUNDATION, FOR THE CHILDREN OF THE WORLD, DBA CHILDREN'S MIRACLE NETWORK, Salt Lake City, UT (US)

(21) Appl. No.: 10/605,495

(22) Filed: Oct. 2, 2003

Related U.S. Application Data
(60) Provisional application No. 60/417,229, filed on Oct. 9, 2002.

(51) Int. Cl. G07D 3/00; A47F 1/00; B61B 1/00; B61D 1/00; E04H 3/00; B65G 47/00

(52) U.S. Cl. 453/3; 186/36

(57) ABSTRACT

A canister has various locations for accepting coins or paper cash and the canister securely stores the coins and paper cash for later retrieval by a sponsor. The canister includes an entertainment device which itself includes at least two or more of a lever, step, gear, ramp, rotating wheel, loop, cup, dish, catapult, audio device, visual device, light, horn, and reflective surface. The coins traverse the entertainment device while under the influence of gravity and the coins are visible to the user during travel through the entertainment device. The canister may also include a launching ramp and a funnel which are configured to accept coins.

### CROSS REFERENCE TO RELATED APPLICATIONS

This application claims priority to, and the benefits of, U.S. Provisional Patent Application entitled “System And Method For An Interactive Donation Canister”, Serial No. 60/417,229 filed on Oct. 9, 2002, the entire contents of which is hereby incorporated by reference.

### FIELD OF INVENTION

The present invention generally relates to a donation device, and more particularly, to a system and method for an interactive donation center which provides multiple options for donating and multiple forms of entertainment.

### BACKGROUND OF INVENTION

Organizations are often looking for new ways to raise funds to support their causes or other philanthropic endeavors. At the same time, because new organizations are often being formed, potential donors are being inundated with requests for donations through various media. These organizations typically use, for example, collection canisters, billboards, television advertisements, mass mailings, mass emails, internet web sites, celebrities, sporting events or other community events to solicit donations. However, many potential donors often simply avoid these solicitations if they are not interested in donating to the specific organization.

Moreover, the requests for donations typically do not necessarily instantly appeal to a large number of potential donors because the requests usually include a serious message and background information about the organization. In an age of video games and interactive internet web sites, potential donors often desire an enhanced entertainment experience to gain their attention. Furthermore, even though the act of donating to a good cause itself should provide sufficient personal satisfaction, many potential donors want to receive additional consideration for their donations. As such, a need exists for a donation method and device which attracts additional donors by providing an entertaining and/or interactive experience.

### SUMMARY OF INVENTION

The invention includes a device which is configured to accept coins or paper cash at one or more locations on the canister and securely store the coins and paper cash for later retrieval by a sponsor. The invention may include a canister to accept and store coins, an entertainment device associated with the canister wherein the entertainment device is disposed between the first end and the second end of said canister. The entertainment device includes at least two or more of a lever, step, gear, ramp, rotating wheel, loop, cup, dish, catapult, audio device, visual device, light, horn, and reflective surface. The coins traverse the entertainment device while under the influence of gravity and the coins are visible to the user during travel through the entertainment device. The canister may include a coin slot and a monitor which is configured to display advertisements of certain charities, the coin slot and the monitor may communicate with a time clock, thereby allowing donations to be correlated with the display advertisements. The coin slots may be configured to accept different types of coins and the canister may also include a launching ramp and a funnel which are configured to accept coins.

In another embodiment, the entertainment donation device includes a canister configured to receive account information, a point of sale terminal associated with the canister wherein the point of sale terminal is configured to accept an account number, and an entertainment device disposed between the first end and the second end of the canister. Upon acceptance of an authorized account number, the canister facilitates interfacing a coin with the entertainment device such that the coin is visible to the user during travel through the entertainment device.

### BRIEF DESCRIPTION OF DRAWINGS

A more complete understanding of the present invention may be facilitated by referring to the following detailed description considered in connection with the following drawings, in which like numerals represent like elements and in which:

FIG. 1 is a drawing of an exemplary embodiment of a donation canister in accordance with the present invention; and

FIG. 2 is a side view showing the access door of an exemplary embodiment of a donation canister in accordance with the present invention.

### DETAILED DESCRIPTION

The present invention is described herein and includes various exemplary embodiments in sufficient detail to enable those skilled in the art to practice the invention, and it should be understood that other embodiments may be realized without departing from the spirit and scope of the invention. Thus, the following detailed description is presented for purposes of illustration only, and not of limitation. The particular implementations shown and described herein are illustrative of the invention and its best mode and are not intended to otherwise limit the scope of the present invention in any way.

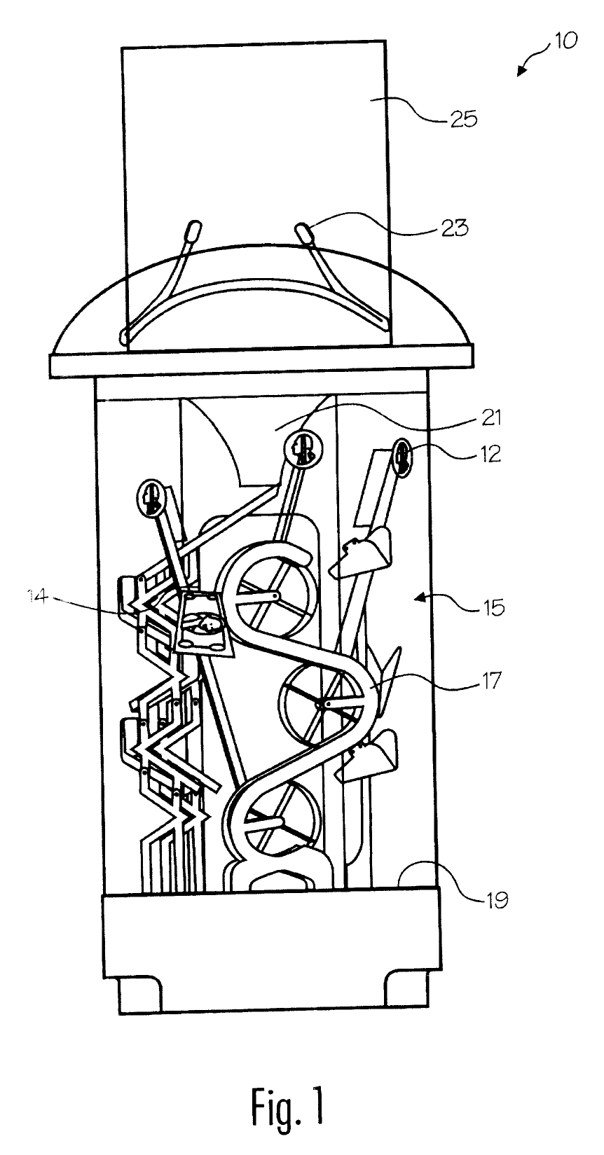

In general, the invention includes a device 10 and method for facilitating entertainment. In one embodiment, as shown in FIG. 1, a canister 15 is configured to accept coins 12 or paper cash 14 at one or more locations and substantially securely store the coins 12 and paper cash 14 in a storage area 19 for later retrieval by a sponsor. In another embodiment, the canister 16 may accept various forms of payment, then display, transmit, announce and/or any other notification of all or any portion of the amount collected over any time period. For example, the canister 15 may display an electronic or mechanical bar which increases in length after each donation until the bar reaches a particular goal. At certain time periods, certain events, certain number of donations and/or certain total amounts collected, the canister 15 may provide a special form of entertainment (e.g., all lights flash, entire canister 15 rotates, etc.).

While the invention shall be described with respect to the collection of coins, one skilled in the art will appreciate that any legal tender, item of value, item having little or no value, financial instrument, disc shaped object, electronic coin and/or any other item or object which may be collected in a similar canister 15 is contemplated in the present invention. In one exemplary embodiment, the canister 15 may include a point of sale terminal whereby, upon acceptance (e.g., authorization, charge, etc) of an financial account number as a form of payment, the canister 15 may activate various components to provide certain entertainment as set forth herein. One skilled in the art will appreciate that the point of sale device may operate through any wireless or wireline network for obtaining authorizations of account codes or reporting information as is known in the art. After receiving the account number, the canister 15 may also automatically drop an existing coin or other object into the entertainment device 17. After receiving the account number, the canister 15 may also provide a coin to the user to allow the user drop the coin into the entertainment device 17 or allow the user access to a device which automatically allows the user drop an existing coin into the entertainment device 17.

In this regard, an “account” or “account number”, as used herein, may include any device, code, number, letter, symbol, digital certificate, smart chip, digital signal, analog signal, biometric or other identifier/indicia suitably configured to allow the consumer to access, interact with or communicate with the system such as, for example, one or more of an authorization/access code, personal identification number (PIN), Internet code, other identification code, and/or the like which may optionally be located on or associated with a rewards card, charge card, credit card, debit card, prepaid card, telephone card, smart card, magnetic stripe card, bar code card, transponder, radio frequency card or an associated account. The account number may be distributed and stored in any form of plastic, electronic, magnetic, radio frequency, wireless, audio and/or optical device capable of transmitting or downloading data from itself to a second device.

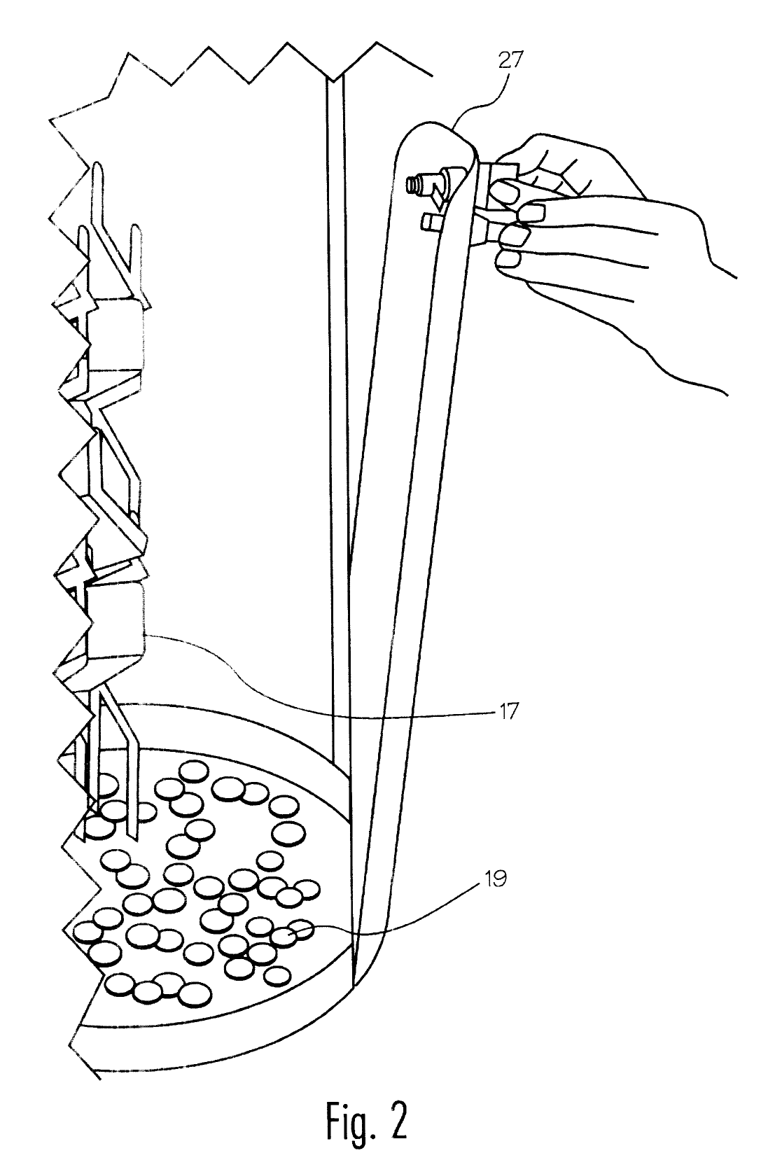

The canister 15 may be any configuration such as, for example, cylindrical, rectangular, triangular, single-chamber, multi-chamber and/or the like. The canister 15 may be comprised of any material, but in one embodiment, the canister 15 is comprised of a clear material such as substantially clear plastic or glass to allow the user to fully or partially view the coin as the coin interfaces with the invention. As best shown in FIG. 2, the canister 15 may include a rear access door 27 for accessing the collected coins and paper bills, for fixing the device or for exchanging or replacing entertainment components. The canister 15 may also include certain sections reserved for general or specific advertisements. For example, advertisements related to the main sponsor may be displayed on the lower end of the base of the canister 15, while a mini billboard 25 may be available on the top of the canister 15 to display advertisements for a particular sponsor or charity. The sign 25 may be removably attached to the rear of the canister, thereby allowing different charities to advertise at different times.

The canister 15 may also include an electronic monitor which may display video information about the charity. The monitor may also alternate displays of different charities. In this regard, the canister 15 may continually accept donations, but the donations may be allocated to certain charities based upon when the donation was received. For example, the canister 15 may include a time clock that communicates with the donation slot such that the time of each donation is recorded. The canister 15 may also associate the time of receipt of a particular donation with the time of the display of a certain portion of a charity video. As such, if the donation is received at the time a certain video is being displayed, the canister 15 may develop a report indicating how many donations or the amount of donations that were received during a certain advertisement or video. The sponsor of the canister 15 may then allocate the donations to the corresponding organizations based on the report.

Upon acceptance of the coin, the canister 15 may provide various forms of entertainment. In one embodiment, after being inserted into the canister 15, the coins may drop, fall, roll, bounce, rebound, flip, catapult and/or the like on its way down to the storage area within the canister 15. The coin may interact with the canister 15 by moving along, through or against various surfaces, layers, levers, steps, gears, ramps, rotating wheels, loops, cups, dishes, catapults, and/or the like. The canister 15 may also include audio or visual stimulation by allowing the coin to activate lights, horns, reflective surfaces, uneven surfaces, monitors, televisions, websites, commercials, signs and/or the like. The entertainment components may be re-organized, replaced or supplemented with additional components, thereby providing a new entertainment experience at different time periods.

The coin may follow a set path or the coin may travel in varied paths depending on the type of coin, the slot the coin is inserted into, the force exerted on the coin and/or environmental conditions. Different coins may travel a different path to differentiate higher value donations. For example, a quarter may interact with more surfaces and travel a longer path than a dime. Multiple coins may also be inserted at one time in order to provide multiple actions at the same time. In one embodiment, the canister 15 includes multiple coin slots 12 with pictures of certain types of coins or paper bills associated with each slot to indicate the desired coin to insert into the particular slot. The potential donor may be able to view the route available for each type of coin such that the donor may be encouraged to increase the donation in order to view the coin travel through a desired route. For example, inserting a quarter into a particular slot may result in the quarter activating a particular wheel that the donor finds more enjoyable.

The canister 15 may also include a launching ramp 23 such that the coin may be set in the ramp, and due to the slope of the ramp, the coin travels down the ramp and gains speed for additional enjoyment. In another embodiment, the canister 15 also includes a bowl-shaped funnel 21 for increasing the speed of the coin and allowing the coin to travel in a spiral path along the inner surface of the funnel 21 until the radius of the coin's path is reduced to a point whereby the coin falls into the center of the funnel 21. A launching ramp 23 may be configured to rest on the rim of the top of the funnel 21 to allow the coin to enter the funnel 21 at a higher rate of speed before entering the spiral trajectory. The invention may also include all of the various embodiments discussed herein such that the coin is inserted into a launching ramp 23, enters the funnel 21, travels through a spiral trajectory, drops into the bottom of the funnel 21, falls into the main cavity of the canister 15, enters into one or more of the ramps and wheels, then falls into the storing bin at the bottom of the canister 15.

In the foregoing specification, the invention has been described with reference to specific embodiments. Various modifications and changes can be made, however, without departing from the scope of the present invention as set forth in the claims below. The specification and figures are to be regarded in an illustrative manner, rather than a restrictive one, and all such modifications are intended to be included within the scope of present invention. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, “includes”, “including”, or any other variations thereof, are intended to cover a non-exclusive inclusion, such that a process, method, article, or apparatus that comprises or includes a list of elements does not include only those elements but may include other elements not expressly listed or inherent to such process, method, article, or apparatus. Further, no element described herein is required for the practice of the invention unless expressly described as “essential” or “critical”.

1. An entertainment donation device including:
a canister configured to accept and collect coins, said canister including a first end and a second end, said first end of said canister configured to accept said coins, said second end of said canister configured to collect said coins;
an entertainment device associated with said canister, said entertainment device disposed between said first end and said second end of said canister, wherein said entertainment device includes at least two or more of a lever, step, gear, ramp, rotating wheel, loop, cup, dish, catapult, audio device, visual device, light, horn, and reflective surface; and,
wherein said coins traverse said entertainment device while under the influence of gravity and said coins are visible to said user during travel through said entertainment device.

2. The entertainment donation device of claim 1, wherein said canister is configured to include at least one of a monitor and sign.

3. The entertainment donation device of claim 1, wherein said coins include at least one of coins and paper cash.

4. The entertainment donation device of claim 1, wherein said canister 15 includes a coin slot, and said coin slot communicates with a time clock.

5. The entertainment donation device of claim 1, wherein said canister includes a coin slot and a monitor which is configured to display advertisements of certain charities, said coin slot and said monitor communicates with a time clock, thereby allowing donations to be correlated with said display advertisements.

6. The entertainment donation device of claim 1, wherein said first end of said canister configured to accept coins includes at least two coin slots, wherein said coin slots are configured to accept different types of coins.

7. The entertainment donation device of claim 1, wherein said canister further includes at least one of a launching ramp and a funnel which are configured to accept coins.

8. An entertainment donation device including:
a canister configured to receive account information, said canister including a first end and a second end;
a point of sale terminal associated with said canister, said point of sale terminal configured to accept an account number;
an entertainment device associated with said canister, said entertainment device disposed between said first end and said second end of said canister, wherein said entertainment device includes at least two or more of a funnel, lever, step, gear, ramp, rotating wheel, loop, cup, dish, catapult, audio device, visual device, light, horn, and reflective surface; and,
wherein, upon acceptance of an authorized account number, said canister facilitates traversing coins through entertainment device while under the influence of gravity and said coins are visible to said user during travel through said entertainment device.
